(19) United States
(12) Patent Application Publication
(10) Pub. No.: US 2015/0030961 A1
(43) Pub. Date: Jan. 29, 2015

(54) FUEL CELLS

(71) Applicants: Hywel Owen Davies, Cheshire (GB); Sarah Elizabeth Wilson, Cheshire (GB); Matthew Alexander Herbert, Cheshire (GB); Kathryn Jane Knuckey, Cheshire (GB)

(72) Inventors: Hywel Owen Davies, Cheshire (GB); Sarah Elizabeth Wilson, Cheshire (GB); Matthew Alexander Herbert, Cheshire (GB); Kathryn Jane Knuckey, Cheshire (GB)

(73) Assignee: ACAL ENERGY LTD, Cheshire (GB)

(21) Appl. No.: 14/383,485

(22) PCT Filed: Mar. 7, 2013
(86) PCT No.: PCT/GB2013/050569

§ 371 Date: Sep. 5, 2014

(30) Foreign Application Priority Data
Mar. 7, 2012 (GB) 1204028.3

(51) Int. Cl. H01M 8/08; H01M 8/20

(52) U.S. Cl. CPC H01M 8/086; H01M 8/20; H01M 2300/0008
USPC 429/482; 429/499

(57) ABSTRACT

A redox fuel cell comprising an anode and a cathode separated by an ion selective polymer electrolyte membrane; means for supplying a fuel to the anode region of the cell; means for supplying an oxidant to the cathode region of the cell; means for providing an electrical circuit between the anode and the cathode; a non-volatile catholyte solution flowing fluid communication with the cathode, the catholyte solution comprising a polyoxometallate redox couple being at least partially reduced at the cathode in operation of the cell, and at least partially re-generated by reaction with the oxidant after such reduction at the cathode, wherein the polyoxometallate is represented by the formula:

Xₐ[Z_{b}M_{c}O_{d}]

Wherein X is selected from hydrogen, alkali metals, alkaline earth metals, ammonium and combinations of two or more thereof; Z is selected from B, P, S, As, Si, Ge, Ni, Rh, Sn, Al, Cu, I, Br, F, Fe, Co, Cr, Zn, H₂, Te, Mn and Se and combinations of two or more thereof; M comprises W and optionally one or more of Mo, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series; a is a number of X necessary to charge balance the [Z_{b}M_{c}O_{d}]^{a-} anion; b is from 0 to 5; c is from 5 to 20; and d is from 1 to 180.

The present invention relates to fuel cells, in particular to indirect or redox fuel cells which have applications in microfuel cells for electronic and portable electronic components, and also in larger fuel cells for the automotive industry. The invention also relates to certain catholyte solutions for use in such fuel cells.

Fuel cells have been known for stationary applications such as back-up power and combined heat and power (CHP), as well as portable and remote power replacing a diesel gen-set or a battery assembly, and automotive and portable electronics technology for very many years although it is only in recent years that fuel cells have become of serious practical consideration. In its simplest form, a fuel cell is an electrochemical energy conversion device that converts fuel and oxidant into reaction product(s), producing electricity and heat in the process. In one example of such a cell, hydrogen is used as fuel, air or oxygen as the oxidant and the product of the reaction is water. The gases are fed respectively into catalysing, diffusion-type electrodes separated by a solid or liquid electrolyte which carries electrically charged ions between the two electrodes. In an indirect or redox fuel cell, the oxidant (and/or fuel in some cases) is not reacted directly at the electrode but instead reacts with the reduced form (oxidized form for fuel) of a redox couple to oxidise it. It is this oxidised species that is fed to the cathode.

There are several types of fuel cell characterised by their different electrolytes. The liquid electrolyte alkali electrolyte fuel cells have inherent disadvantages in that the electrolyte dissolves CO₂ and needs to be replaced periodically. Polymer electrolyte or PEM-type cells with proton-conducting solid cell membranes are acidic and avoid this problem. However, it has proved difficult in practice to attain power outputs from such systems approaching the theoretical maximum level, due to the relatively poor electrocatalysis of the oxygen reduction reaction. In addition, expensive noble metal electrocatalysts are often used, and it has proved difficult provide durability to meet market demands, in addition especially with a sufficient reduction in the levels of such metals to be commercially viable.

U.S. Pat. No. 3,152,013 discloses a gaseous fuel cell comprising a cation-selective permeable membrane, a gas permeable catalytic electrode and a second electrode, with the membrane being positioned between the electrodes and in electrical contact only with the gas permeable electrode. An aqueous catholyte is provided in contact with the second electrode and the membrane, the catholyte including an oxidant couple therein. Means are provided for supplying a fuel gas to the permeable electrode and for supplying a gaseous oxidant to the catholyte for oxidising reduced oxidant material. The preferred catholyte and redox couple is HBr/KBr/Br₂. Nitrogen oxide is disclosed as a preferred catalyst for oxygen reduction, but with the consequence that pure oxygen is required as the oxidant, the use of air as the oxidant requiring the venting of noxious nitrogen oxide species.

An acknowledged problem concerning electrochemical fuel cells is that the theoretical potential of a given electrode reaction under defined conditions can be calculated but never completely attained. Imperfections in the system inevitably result in a loss of potential to some level below the theoretical potential attainable from any given reaction. Previous attempts to reduce such imperfections include the selection of catholyte additives which undergo oxidation-reduction reactions in the catholyte solution. For example, U.S. Pat. No. 3,294,588 discloses the use of quinones and dyes in this capacity. Another redox couple which has been tried is the vanadate/vanadyl couple, as disclosed in U.S. Pat. No. 3,279,949.

According to U.S. Pat. No. 3,540,933, certain advantages could be realised in electrochemical fuel cells by using the same electrolyte solution as both catholyte and anolyte. This document discloses the use of a liquid electrolyte containing more than two redox couples therein, with equilibrium potentials not more than 0.8V apart from any other redox couple in the electrolyte.

The matching of the redox potentials of different redox couples in the electrolyte solution is also considered in U.S. Pat. No. 3,360,401, which concerns the use of an intermediate electron transfer species to increase the rate of flow of electrical energy from a fuel cell.

Several types of proton exchange membrane fuel cells exist. For example, in U.S. Pat. No. 4,396,687 a fuel cell is disclosed which comprises regenerable anolyte and catholyte solutions. The anolyte solution is one which is reduced from an oxidised state to a reduced state by exposure of the anolyte solution to hydrogen. According to U.S. Pat. No. 4,396,687, preferred anolyte solutions are tungstosilicic acid (H₄SiW₁₂O₄₀) or tungstophosphoric acid (H₃PW₁₂O₄₀) in the presence of a catalyst.

The preferred catholyte solution of U.S. Pat. No. 4,396,687 is one which is re-oxidised from a reduced state to an oxidized state by direct exposure of the catholyte solution to oxygen. The catholyte of U.S. Pat. No. 4,396,687 includes a mediator component comprising a solution of VOSO₄. The mediator functions as an electron sink which is reduced from an oxidation state of V^{(v)} to V^{(IV)}. The catholyte also includes a catalyst for regenerating the mediator to its oxidised state, (VO₂)₂SO₄. The catalyst present in the catholyte of U.S. Pat. No. 4,396,687 is a polyoxometallate (POM) solution, namely H₅PMo₁₂V₂O₄₀. This disclosure, as well as that of U.S. Pat. No. 4,407,902 from the same company, specifically mentions the addition of VOSO₄ to a catholyte containing H₅PMo₁₀V₂O₂₄ with concentrations of 0.8M VOSO₄ and 0.059M H₅PMo₁₀V₂O₄₀.

Besides U.S. Pat. No. 4,396,687, a number of other attempts to use oxometallate catalysts have been made. For example, in U.S. Pat. No. 5,298,343, cathode systems comprising solid metal catalysts, oxometallates and metallic acids, such as molybdic acid are disclosed.

In addition, WO96/31912 describes the use of embedded polyoxometallates in an electrical storage device. The redox nature of the polyoxometallate is employed in conjunction with carbon electrode material to temporarily store electrons.

US2005/0112055 discloses the use of polyoxometallates for catalysing the electrochemical generation of oxygen from water. GB1176633 discloses a solid molybdenum oxide anode catalyst.

US2006/0024539 discloses a reactor and a corresponding method for producing electrical energy using a fuel cell by selectively oxidising CO at room temperature using polyoxometallate compounds and transition metal compounds over metal-containing catalysts.

EP-A-0228168 discloses activated carbon electrodes which are said to have improved charge storage capacity due to the adsorption of polyoxometallate compounds onto the activated carbon.

PCT/GB2007/050151 discloses a fuel cell that includes a polyoxometallate redox couple represented by the formula Xₐ[Z_{b}M_{c}O_{d}], wherein X is selected from hydrogen, alkali metals, alkaline earth metals, ammonium and combinations of two or more thereof, Z is selected from B, P, S, As, Si, Ge, Ni, Rh, Sn, Al, Cu, I, Br, F, Fe, Co, Cr, Zn, H₂, Te, Mn and Se and combinations of two or more thereof, M is a metal selected from Mo, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series and combinations of two or more thereof, a is a number of X necessary to charge balance the [M_{c}O_{d}] anion, b is from 0 to 20, c is from 1 to 40, and d is from 1 to 180. The particularly preferred embodiments involve a molybdenum-vanadium polyoxometallate.

Prior art fuel cells all suffer from one or more of the following disadvantages:

They are inefficient; they are expensive and/or expensive to assemble; they use expensive and/or environmentally unfriendly materials; they yield inadequate and/or insufficiently maintainable or durable current densities and/or cell potentials; they are too large in their construction; they operate at too high a temperature; they produce unwanted by-products and/or pollutants and/or noxious materials; and they have not found practical, commercial utility in portable applications such as automotive and portable electronics. Those that use polyoxometallate compounds also have the problem that only a limited range of structures are available and some compositions of polyoxometallate can lead to lower solubility than is desired to maximise fuel cell performance.

It is an object of the present invention to overcome or ameliorate one or more of the aforesaid disadvantages. It is a further object of the present invention to provide an improved catholyte solution for use in redox fuel cells.

Accordingly, the present invention provides a redox fuel cell comprising an anode and a cathode separated by an ion selective polymer electrolyte membrane; means for supplying a fuel to the anode region of the cell; means for supplying an oxidant to the cathode region of the cell; means for providing an electrical circuit between the anode and the cathode; and a non-volatile catholyte solution flowing fluid communication with the cathode, the catholyte solution comprising a polyoxometallate redox couple being at least partially reduced at the cathode in operation of the cell, and at least partially re-generated by reaction with the oxidant after such reduction at the cathode. The polyoxometallate of the present invention is represented by the formula:

Xₐ[Z_{b}M_{c}O_{d}]
wherein:
X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M comprises W and optionally one or more of Mo, V, Nb, Ta, Mn, Fe, Co, Cr, Ni, Zn Rh, Ru, Tl, Al, Ga, In and other metals selected from the 1^{st}, 2^{nd}, and 3^{rd} transition metal series and the lanthanide series;
a is a number of X necessary to charge balance the [Z_{b}M_{c}O_{d}]^{a-} anion;
b is from 0 to 5;
c is from 5 to 30; and
d is from 1 to 180.

It is to be understood that such formulae used herein are generic formulae and that a distribution of related species may exist in solution.

The use of tungsten in the polyoxometallate compound compared to the use of the other compounds disclosed in the prior art has numerous benefits. It has been found that the tungsten polyoxometallates of the present invention are more stable at low pH and can be synthetically manipulated to a greater extent than molybdenum analogues. It is therefore possible to create a variety of different structures that are not available when using other polyoxometallate compounds, such as those containing molybdenum, and to use a wider range of materials.

Further, some compositions of polyoxometallates known in the prior art can have a lower solubility than is desired for maximum fuel cell performance. It has surprisingly been found that solubility can be improved by using tungsten polyoxometallate catalysts of the present invention. The tungsten polyoxometallates of the present invention also provide an increased electrochemical performance when compared to the polyoxometallates of the prior art.

Preferred ranges for b are from 0 to 5, more preferably 0 to 2.

Preferred ranges for c are from 5 to 30, preferably from 10 to 18 and most preferably 12.

Preferred ranges for d are from 1 to 180, preferably from 30 to 70, more preferably 34 to 62 and most preferably 34 to 40.

The polyoxometallate of the present invention preferably contains from 1 to 6 vanadium centres. Example formulae therefore include Xₐ[Z₁W₁₂₋ₓVₓO₄₀] where x=1 to 6. In one embodiment of the present invention, the polyoxometallate has the formula Xₐ[Z₁W₉V₃O₄₀]. In another embodiment, the polyoxometallate has the formula Xₐ[Z₁W₁₁V₁O₄₀].

Other preferred polyoxometallate variants include:

Xₐ[Z_{b}WᵥM¹_{w}M²ₓM³_{y}M⁴_{z}O_{d}]

Wherein X, Z, a, b and d have the meanings and values ascribed herein and wherein M¹, M², M³, and M⁴ are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x+y+z=c, the value of which is as previously ascribed; and wherein v is at least 1.

Other preferred polyoxometallate variants include:

Xₐ[Z_{b}WᵥM¹_{w}M²ₓM³_{y}O_{d}]

Wherein X, Z, a, b and d have the meanings and values ascribed herein and wherein M¹, M² and M³, and are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x+y=c, the value of which is as previously ascribed; and wherein v is at least 1.

Other preferred polyoxometallate variants include:

Xₐ[Z_{b}WᵥM¹_{w}M²ₓO_{d}]

Wherein X, Z, a, b and d have the meanings and values ascribed herein and wherein M¹ and M² are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x=c, the value of which is as previously ascribed; and wherein v is at least 1.

Specifically preferred examples of these types of polyoxometallate variants include those in which M¹ is vanadium and M² is molybdenum.

In a particularly preferred variant v=w=x and, in the case where c is 12, v=w=x=4—as in W₄Mo₄V₄.

Other preferred polyoxometallate variants include:

Xₐ[Z_{b}WᵥM¹_{w}O_{d}]

Wherein X, Z, a, b and d have the meanings and values ascribed herein and wherein M¹ is selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w=c, the value of which is as previously ascribed; and wherein v is at least 1.

B, P, S, As, Si, Ge, Al, Co, Mn or Se are particularly preferred for Z, with P, S, Si, Al or Co being most preferred. The successful use of such a range of atoms would not be possible with a polyoxometallate that contains, for example, molybdenum, as outlined in the prior art. In particular, the use of silicon and aluminium in combination with tungsten in the polyoxometallates of the present invention has surprisingly been shown to significantly improve the performance of the fuel cells. For example, tungsten polyoxometallates with aluminium or silicon demonstrate more reversible electrochemical properties at a higher potential compared to the polyoxometallates commonly found in the prior art.

M preferably consists of 1 to 3 different elements. In one embodiment, M is a combination of tungsten, vanadium and/or molybdenum. The polyoxometallate may be absent of molybdenum, and further may be absent of any metals other than tungsten or vanadium. The polyoxometallate may alternatively consist of tungsten. M preferably includes more than two, more than four or more than six tungsten atoms.

Hydrogen, or a combination of hydrogen and an alkali metal and/or alkaline earth metal are particularly preferred examples for X. X preferably comprises a hydrogen ion or a combination of a hydrogen ion and an alkali metal ion, and more preferably comprises one or more of H⁺, Na⁺, K⁺ or Li⁺. Preferred combinations include hydrogen, hydrogen with sodium and hydrogen with potassium.

In a preferred embodiment, the polyoxometallate may be H₆[AlW₁₁V₁O₄₀]. Alternatively the polyoxometallate may be X₇[SiW₉V₃O₄₀] where, as an example, X can give rise to the general formula K₂H₅[SiW₉V₃O₄₀]. Further, a mixture of these or other polyoxometallate catalysts is also envisaged.

The concentration of the polyoxometallate in the catholyte solution is between 0.01M and 0.6M. If the polyoxometallate of the present invention is the major constituent of the catholyte solution, a concentration range of 0.1M-0.6M is preferred, whilst 0.15M-0.4M is most preferred.

In one preferred embodiment of the invention, the ion selective PEM is a cation selective membrane which is selective in favour of protons versus other cations.

The cation selective polymer electrolyte membrane may be formed from any suitable material, but preferably comprises a polymeric substrate having cation exchange capability. Suitable examples include fluororesin-type ion exchange resins and non-fluororesin-type ion exchange resins. Fluororesin-type ion exchange resins include perfluorocarboxylic acid resins, perfluorosulfonic acid resins, and the like. Perfluorosulfonic acid resins are preferred, for example “Nafion” (Du Pont Inc.), “Flemion” (Asahi Gas Ltd), “Aciplex” (Asahi Kasei Inc) and the like. Non-fluororesin-type ion exchange resins include polyvinylalcohols, polyalkylene oxides, styrene-divinylbenzene ion exchange resins and the like, and metal salts thereof. Preferred non-fluororesin-type ion exchange resins include polyalkylene oxide-alkali metal salt complexes. These are obtainable by polymerizing an ethylene oxide oligomer in the presence of lithium chlorate or another alkali metal salt, for example. Other examples include phenolsulphonic acid, polystyrene sulphonic, polytriflurostyrene sulphonic, sulphonated trifluorostyrene, sulphonated copolymers based on α,β,β triflurostyrene monomer, radiation-grafted membranes. Non-fluorinated membranes include sulphonated poly(phenylquinoxalines), poly (2,6 diphenyl-4-phenylene oxide), poly(arylether sulphone), poly(2,6-diphenylenol), acid-doped polybenzimidazole, sulphonated polyimides, styrene/ethylene-butadiene/styrene triblock copolymers, partially sulphonated polyarylene ether sulphone, partially sulphonated polyether ether ketone (PEEK), and polybenzyl suphonic acid siloxane (PBSS).

In some cases, it may be desirable for the ion selective polymer electrolyte membrane to comprise a bimembrane. The bimembrane, if present, will generally comprise a first cation selective membrane and a second anion selective membrane. In this case, the bimembrane may comprise an adjacent pairing of oppositely charge selective membranes. For example, the bimembrane may comprise at least two discreet membranes which may be placed side-by-side with an optional gap therebetween. Preferably, the size of the gap, if any, is kept to a minimum in the redox cell of the invention. The use of a bimembrane may be used in the redox fuel cell of the invention to maximise the potential of the cell, by maintaining the potential due to a pH drop between the anode and catholyte solution. Without being limited by theory, in order for this potential to be maintained in the membrane system, at some point in the system, protons must be the dominant charge transfer vehicle. A single cation-selective membrane may not achieve this to the same extent due to the free movement of other cations from the catholyte solution in the membrane.

In this case, the cation selective membrane may be positioned on the cathode side of the bimembrane and the anion selective membrane may be positioned on the anode side of the bimembrane. In this case, the cation selective membrane is adapted to allow protons to pass through the membrane from the anode side to the cathode side thereof in operation of the cell. The anion selective membrane is adapted substantially to prevent cationic materials from passing therethrough from the cathode side to the anode side thereof, although in this case anionic materials may pass from the cathode side of the anionic-selective membrane to the anode side thereof, whereupon they may combine with protons passing through the membrane in the opposite direction. Preferably, the anion selective membrane is selective for hydroxyl ions and combination with protons therefore yields water as a product.

In a second embodiment of the invention the cation selective membrane is positioned on the anode side of the bimembrane and the anion selective membrane is positioned on the cathode side of the bimembrane. In this case, the cation selective membrane is adapted to allow protons to pass through the membrane from the anode side to the cathode side thereof in operation of the cell. In this case, anions can pass from the cathode side into the interstitial space of the bimembrane, and protons will pass from the anode side. It may be desirable in this case to provide means for flushing such protons and anionic materials from the interstitial space of the bimembrane. Such means may comprise one or more perforations in the cation selective membrane, allowing such flushing directly through the membrane. Alternatively, means may be provided for channeling flushed materials around the cation selective membrane from the interstitial space to the cathode side of the said membrane.

According to another aspect of the present invention, there is provided a method of operating a proton exchange membrane fuel cell comprising the steps of:

a) forming H⁺ ions at an anode situated adjacent to an ion selective polymer electrolyte membrane;

b) supplying the catholyte of the invention with its redox couple in an oxidised state to a cathode situated oppositely adjacent to the ion selective polymer electrolyte membrane; and

c) allowing the catalyst to become reduced upon contact with the cathode concomitantly with H⁺ ions passing through the membrane to balance charge.

In a preferred embodiment, the catholyte is supplied from a catholyte reservoir. In other preferred embodiments, the ion selective polymer electrolyte membrane is a proton exchange membrane.

The method of the above aspect may additionally comprise the step of:

d) passing the catholyte from the cathode to a reoxidation zone wherein the catalyst is reoxidised.

In an especially preferred embodiment, the method of the above aspect comprises the step of:

e) passing the catholyte from the reoxidation zone to the catholyte reservoir.

In a further embodiment, the cell is cyclic and the catalyst in the cathode can be repeatedly oxidised and reduced without having to be replaced.

The fuel cell of the invention may comprise a reformer configured to convert available fuel precursors such as natural gas, LPG, LNG, gasoline or low molecular weight alcohols into a fuel gas (eg hydrogen) through a steam reforming reaction. The cell may then comprise a fuel gas supply device configured to supply the reformed fuel gas to the anode chamber.

It may be desirable in certain applications of the cell to provide a fuel humidifier configured to humidify the fuel, eg hydrogen. The cell may then comprise a fuel supply device configured to supply the humidified fuel to the anode chamber.

An electricity loading device configured to load an electric power may also be provided in association with the fuel cell of the invention.

Preferred fuels include hydrogen, low molecular weight alcohols, aldehydes and carboxylic acids, sugars and biofuels as well as LPG, LNG or gasoline.

Preferred oxidants include air, oxygen and peroxides.

The anode in the redox fuel cell of the invention may for example react with hydrogen gas or methanol; other low molecular weight alcohols such as ethanol or propanol; dipropylene glycol; ethylene glycol; aldehydes formed from these; and acid species such as formic acid, ethanoic acid etc. In addition, the anode may be formed from a bio-fuel cell type system where a bacterial species consumes a fuel and either produces a mediator which is oxidized at the electrode, or the bacteria themselves are adsorbed at the electrode and directly donate electrons to the anode.

The cathode in the redox fuel cell of the invention may comprise a cathodic material such as carbon, gold, platinum, nickel or metal oxide species. However, it is preferable that expensive cathodic materials are avoided and therefore preferred cathodic materials include carbon, nickel and metal oxide. One preferable material for the cathodes is reticulated vitreous carbon or carbon fibre based electrodes such as carbon felt. Another is nickel foam. The cathodic material may be constructed from a fine dispersion of particulate cathodic material, the particulate dispersion being held together by a suitable adhesive, or by a proton conducting polymeric material. The cathode is designed to create maximum flow of catholyte solution to the cathode surface. Thus it may consist of shaped flow regulators or a three dimensional electrode; the liquid flow may be managed in a flow-by arrangement where there is a liquid channel adjacent to the electrode, or in the case of the three dimensional electrode, where the liquid is forced to flow through the electrode. It is intended that the surface of the electrode is also the electrocatalyst, but it may be beneficial to adhere the electrocatalyst in the form of deposited particles on the surface of the electrode.

The redox couple flowing in solution in the cathode chamber in operation of the cell is used in the invention as a catalyst for the reduction of oxygen in the cathode chamber, in accordance with the following (wherein Sp is the redox couple species):

O₂+4Sp_{red}+4H⁺→2H₂O+4SPₒₓ

The polyoxometallate redox couple, and any other ancillary redox couple, utilised in the fuel cell of the invention should be non-volatile and is preferably soluble in aqueous solvent. Preferred redox couples should react with the oxidant at a rate effective to generate a useful current in the electrical circuit of the fuel cell, and react with the oxidant such that water is the ultimate end product of the reaction.

The fuel cell of the present invention requires the presence of between 0.01M and 0.6M of a polyoxometallate species in the catholyte solution. The polyoxometallates as outlined above can comprise 1% to 100% of the total amount of redox species in the cell. The fuel cell works when the tungsten polyoxometallates as outlined above are the major constituents of the catholyte. In this case, the concentration of the polyoxometallate is preferably between 0.1M and 0.6M, more preferably between 0.15M and 0.4M.

However, in some circumstances it may also be advantageous to include other redox couples in the catholyte solution in addition to the polyoxometallate species of the present invention. The polyoxometallates of the present invention may therefore be minor constituents of the catholyte solution and so smaller concentrations than above may be used.

There are many suitable examples of such ancillary redox couples, including ligated transition metal complexes, triphenylamine type materials as described in patent WO2011015875, other polyoxometallate species and combinations thereof. Specific examples of suitable transition metal ions which can form such complexes include manganese in oxidation states II-V, iron I-IV, copper I-III, cobalt I-III, nickel I-III, chromium (II-VII), titanium II-IV, tungsten IV-VI, vanadium II-V and molybdenum II-VI. Ligands can contain carbon, hydrogen, oxygen, nitrogen, sulphur, halides or phosphorus. Ligands may be chelating complexes such as Fe/EDTA and Mn/EDTA, NTA, 2-hydroxyethylenediaminetriacetic acid, or non-chelating ligands such as cyanide.

A preferred additional polyoxometallate compound for use in the fuel cell of the present invention in combination with the polyoxometallates of the present invention is represented by the formula:

Xₐ[Z_{b}M_{c}O_{d}]
wherein:
X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M is a metal selected from Mo, W, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series and combinations of two or more thereof;
a is a number of X necessary to charge balance the [Z_{b}M_{c}O_{d}]^{a-} anion;
b is from 0 to 20;
c is from 1 to 40; and
d is from 1 to 180.

In some embodiments, the additional polyoxometallate comprises H₆₋ₓNaₓPMo₉V₃O₄₀ where x=0-3. In still further embodiments, the additional polyoxometallate comprises H₆₋ₓNaₓPMo₈V₄O₄₀ where x=0-4.

In some embodiments, the polyoxometallate of the present invention is present at a concentration of between 5% and 15% the total amount of polyoxometallate in a fuel cell. It has surprisingly been found that the addition of this amount of the polyoxometallate of the present invention improves the performance of the fuel cells of the prior art.

The triphenylamine type materials for use in combination with the polyoxometallates of the present invention comprise formula (I):

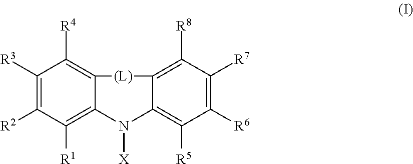

wherein:

X is selected from hydrogen and from functional groups comprising halogen, hydroxyl, amino, protonated amino, imino, nitro, cyano, acyl, acyloxy, sulphate, sulfonyl, sulfinyl, alkyamino, protonated alkylamino, quaternary alkylammonium, carboxy, carboxylic acid, ester, ether, amido, sulfonate, sulfonic acid, sulphonamide, phosphonic acid, phosphonate, phosphate, alkylsulfonyl, arylsulfonyl, alkoxycarbonyl, alkylsulfinyl, arylsulfinyl, alkylthio, arylthio, alkyl, alkoxy, oxyester, oxyamido, aryl, fused-aryl, arylamino, aryloxy, heterocycloalkyl, heteroaryl, fused-heteroaryl, (C₂-C₅)alkenyl, (C₂-C₅)alkynyl, azido, phenylsulfonyloxy, amino acid or a combination thereof;

R¹⁻⁸ are independently selected from hydrogen, halogen, hydroxyl, amino, protonated amino, imino, nitro, cyano, acyl, acyloxy, sulphate, sulfonyl, sulfinyl, alkyamino, protonated alkylamino, quaternary alkylammonium, carboxy, carboxylic acid, ester, ether, amido, sulfonate, sulfonic acid, sulphonamide, phosphonic acid, phosphonate, phosphate, alkylsulfonyl, arylsulfonyl, alkoxycarbonyl, alkylsulfinyl, arylsulfinyl, alkylthio, arylthio, alkyl, alkoxy, oxyester, oxyamido, aryl, fused-aryl, arylamino, aryloxy, heterocycloalkyl, heteroaryl, fused-heteroaryl, (C₂-C₅)alkenyl, (C₂-0C₅)alkynyl, azido, phenylsulfonyloxy, amino acid or a combination thereof;

R¹ and X and/or R⁵ and X may together form an optionally substituted ring structure;

R¹ and R² and/or R² and R³ and/or R³ and R⁴ and/or R⁴ and R⁸ and/or R⁸ and R⁷ and/or R⁷ and R⁶ and/or R⁶ and R⁵ may together form an optionally substituted ring structure; wherein

(L) indicates the optional presence of a linking bond or group between the two neighbouring aromatic rings of the structure, and when present may form an optionally substituted ring structure with one or both of R⁴ and R⁸, and wherein at least one substituent group of the structure is a charge-modifying substituent.

The fuel cell of the invention may operate straightforwardly with a redox couple catalysing in operation of the fuel cell the reduction of oxidant in the cathode chamber. However, in some cases, and with some redox couples, it may be necessary and/or desirable to incorporate a catalytic mediator in the cathode chamber.

Also provided is a catholyte solution for use in a redox fuel cell according to any preceding claim, the solution comprising between 0.01M and 0.6M of a polyoxometallate, as well as the use of a fuel cell as described herein to produce electricity.

Various aspects of the present invention will now be more particularly described with reference to the following figures which illustrate embodiments of the present invention:

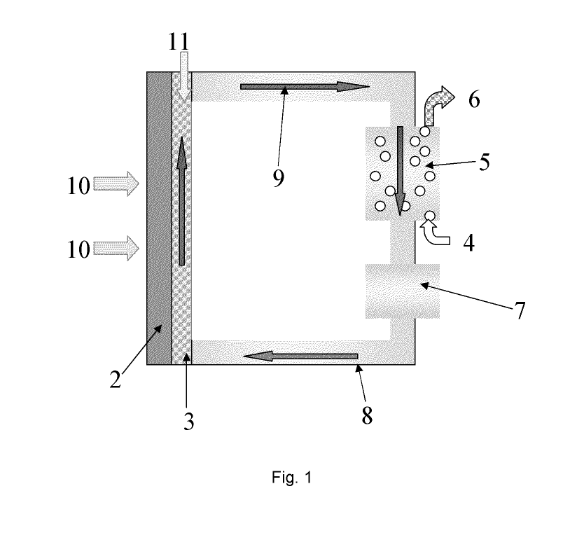

FIG. 1 illustrates a schematic view of the cathode compartment of a fuel cell in accordance with the present invention;

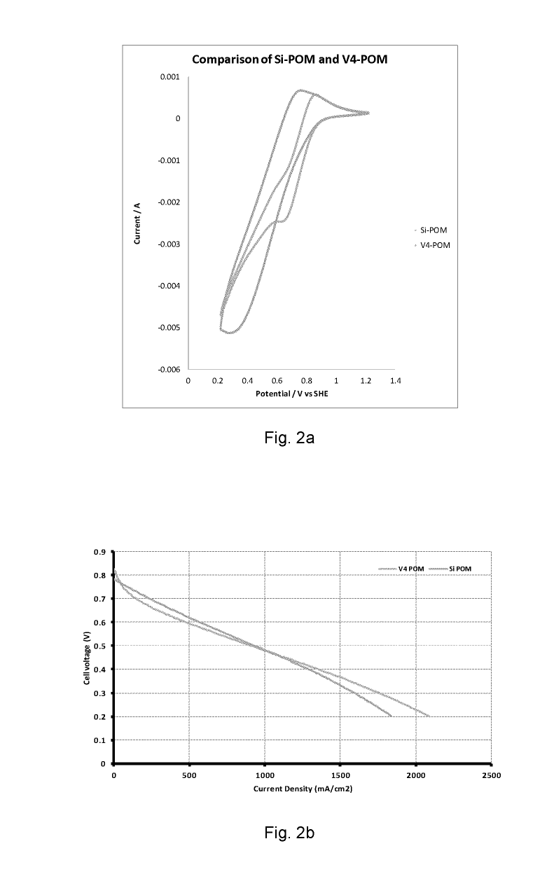

FIGS. 2a and b are graphs showing comparative data demonstrating the difference in performance between a fuel cell using a prior art polyoxometallate (Na₄H₃PMo₈V₄O₄₀, “V4-POM”) and one using a tungsten containing polyoxometallate with the formula K₂H₅SiW₉V₃O₄₀, “Si-POM”;

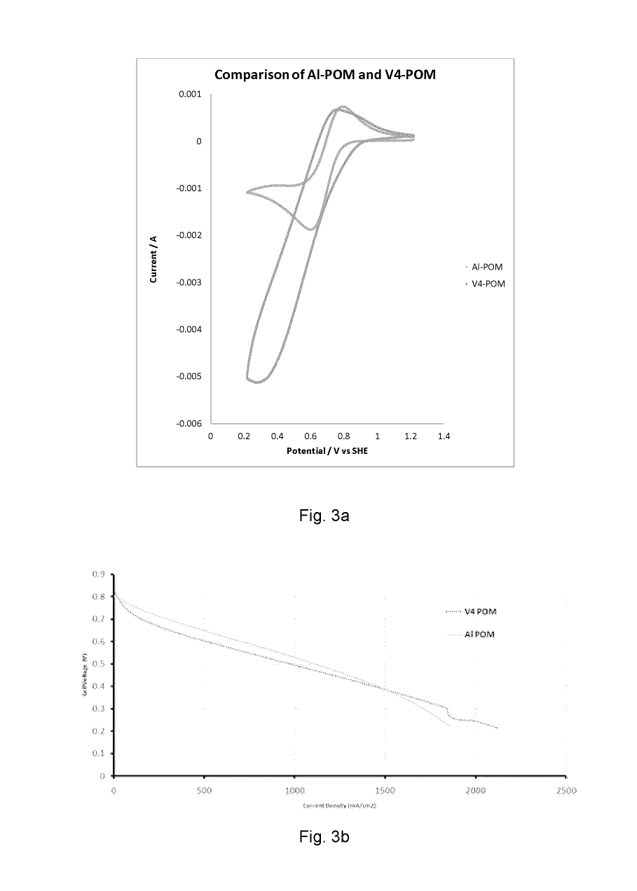

FIGS. 3a and b are graphs showing further comparative data demonstrating the difference in performance between a fuel cell using a prior art (Na₄H₃PMoₛV₄O₄₀, “V4-POM”) and one using a tungsten polyoxometallate with the formula H₆AlW₁₁V₁O₄₀, “Al-POM”;

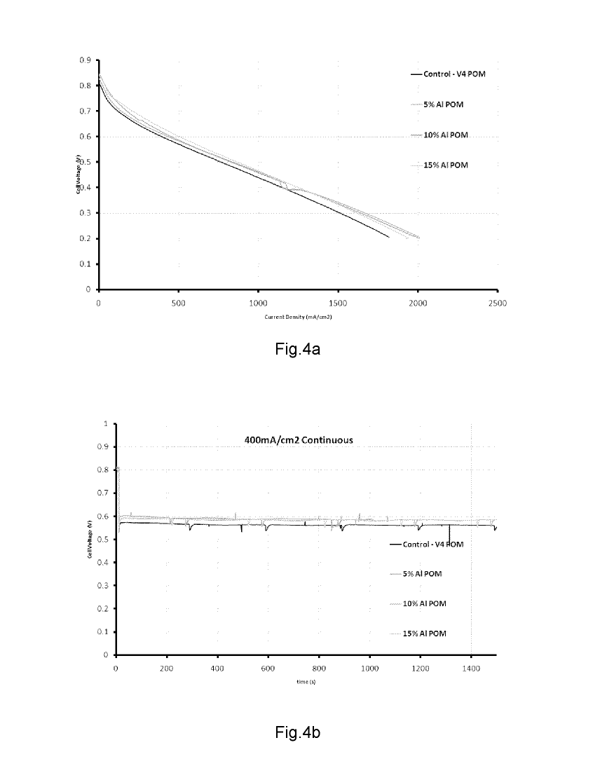

FIGS. 4a and b are graphs showing further comparative data demonstrating the difference in performance between a fuel cell using only a prior art polyoxometallate (Na₄H₃PMo₈V₄O₄₀, “V4-POM”) and one using the same polyoxometallate with additionally either 5%, 10% or 15% of a tungsten polyoxometallate with the formula H₆AlW₁₁V₁O₄₀, “Al-POM”.

Referring to FIG. 1, there is shown the cathode side of fuel cell 1 in accordance with the invention comprising a polymer electrolyte membrane 2 separating an anode (not shown) from cathode 3. Cathode 3 comprises in this diagram reticulated carbon and is therefore porous. However, other cathodic materials such as platinum may be used. Polymer electrolyte membrane 2 comprises cation selective Nafion 112 membrane through which protons generated by the (optionally catalytic) oxidation of fuel gas (in this case hydrogen) in the anode chamber pass in operation of the cell. Electrons generated at the anode by the oxidation of fuel gas flow in an electrical circuit (not shown) and are returned to cathode 3. Fuel gas (in this case hydrogen) is supplied to the fuel gas passage of the anode chamber (not shown), while the oxidant (in this case air) is supplied to oxidant inlet 4 of cathode gas reaction chamber 5. Cathode gas reaction chamber 5 (the catalyst reoxidation zone) is provided with exhaust 6, through which the by-products of the fuel cell reaction (eg water and heat) can be discharged.

A catholyte solution comprising the oxidised form of the polyoxometallate redox catalyst is supplied in operation of the cell from catholyte reservoir 7 into the cathode inlet channel 8. The catholyte passes into reticulated carbon cathode 3, which is situated adjacent membrane 2. As the catholyte passes through cathode 3, the polyoxometallate catalyst is reduced and is then returned to cathode gas reaction chamber 5 via cathode outlet channel 9.

For the electrochemical comparisons of cyclic voltammograms shown in the FIGS. 2a and 3a, measurements have been made at 65° C. using a three electrode system including a polished glassy carbon working electrode, platinum counter electrode and saturated calomel reference electrode. All potentials have been converted and are given with respect to a standard hydrogen electrode (SHE). Approximately 0.3M concentrations of POM catholytes have been used with no additional supporting electrolyte.

FIGS. 2a and 3a respectively show that the Si and Al tungsten polyoxometallate materials of the present invention demonstrate more reversible electrochemical properties at a higher potential compared to the V4 polyoxometallates that are commonly found in the prior art.

Fuel cell data presented in FIG. 2b was collected using a 25 cm² single cell with a felt (GFD 2.5 mm) graphitic carbon cathode and an Ion Power NRE212 membrane. H₂ was run dead ended with pressure set to 0.7 bar. The cell temperature was monitored and maintained at 80° C. The data shown in the polarisation curve shows that the initial slope for the Si tungsten polyoxometallate material (Si-POM) is less steep than for the V4-POM, meaning that a higher potential is recorded at a set point of 400 mA/cm² for the Si tungsten polyoxometallate system (Si-POM). The shallower slope illustrates the more rapid electrode kinetics seen in FIG. 2a.

Fuel cell data presented in FIG. 3b was collected using a 25 cm² single cell with a felt (GFD 2.5EA, SGL) graphitic carbon cathode and an Ion Power NRE212 membrane. H₂ was run dead ended with pressure set to 0.8 bar and a catholyte flow rate of 200ml/min was used. The cell temperature was monitored and maintained at 80° C. The data in the polarisation curve shows that when the open circuit potentials of the two materials are adjusted to approximately the same level, there is no initial drop for the Al tungsten polyoxometallate material (Al-POM) as is seen for the V4-POM. A higher potential is recorded at a set point of 400 mA/cm² for the Al tungsten polyoxometallate system (Al-POM).

For FIGS. 4a and b, a 25 cm² single cell was built utilising a felt electrode (Sigracell GFD 2.5 EA) and an Ion Power NRE212 MEA. H₂ was run dead ended with pressure set to 0.8 bar and a catholyte flow rate of 200ml/min was used. The cell temperature was monitored and maintained at 80° C. After running a standard V4-POM experiment, Al tungsten polyoxometallate (Al-POM) was added in 5, 10 and 15% quantities with a polarisation curve and steady state measurement at 400 mA/cm² being recorded for each. The fuel cell data presented shows that both the polarisation curve and the steady state measurement are improved upon the addition of Al-POM to the V4-POM. It appears that the initial 5% addition is sufficient to induce a significant performance enhancement with subsequent additions having a lesser effect.

1. A redox fuel cell comprising an anode and a cathode separated by an ion selective polymer electrolyte membrane; means for supplying a fuel to the anode region of the cell; means for supplying an oxidant to the cathode region of the cell; means for providing an electrical circuit between the anode and the cathode; a non-volatile catholyte solution flowing fluid communication with the cathode, the catholyte solution comprising a polyoxometallate redox couple being at least partially reduced at the cathode in operation of the cell, and at least partially re-generated by reaction with the oxidant after such reduction at the cathode,
wherein the polyoxometallate is represented by the formula:
Xₐ[Z_{b}M_{c}O_{d}]
wherein:
X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M comprises W and optionally one or more of Mo, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series;
a is a number of X necessary to charge balance the [Z_{b}M_{c}Oₐ]^{a-} anion;
b is from 0 to 5;
c is from 5 to 30; and
d is from 1 to 180.

2. A redox fuel cell according to claim 1 wherein:
a. b is from 0 to 2;
b. c is from 10 to 18; and/or
c. d is from 30 to 70.

3. A redox fuel cell according to claim 2 wherein:
a. c is 12; and or
b. d is from 34 to 62.

4. A redox fuel cell according to claim 3 wherein d is from 34 to 40.

5. A redox fuel cell according to claim 1 wherein the polyoxometallate is represented by the formula:
Xₐ[Z_{b}WᵥM¹_{w}M²ₓM³_{y}M⁴_{z}O_{d}]
wherein M¹, M², M³, and M⁴ are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x+y+z=c; and wherein v is at least 1.

6. A redox fuel cell according to claim 1 wherein the polyoxometallate is represented by the formula:
Xₐ[Z_{b}WᵥM¹_{w}M²ₓM³_{y}O_{d}]
wherein M¹, M² and M³, and are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x+y=c; and wherein v is at least 1.

7. A redox fuel cell according to claim 1 wherein the polyoxometallate is represented by the formula:
Xₐ[Z_{b}WᵥM¹_{w}M²ₓO_{d}]
wherein M¹ and M² are independently selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w+x=c; and wherein v is at least 1.

8. A redox fuel cell according to claim 1 wherein the polyoxometallate is represented by the formula:
Xₐ[Z_{b}WᵥM¹_{w}O_{d}]
wherein M¹ is selected from one or more of Mo, V, Nb, Ta, Mn, Fe, Co, Cr, Ni, Zn Rh, Ru, Tl, Al, Ga, In, and other metals selected from the 1^{st}, 2^{nd} and 3^{rd} transition metal series and the lanthanide series of metals; wherein v+w=c; and wherein v is at least 1.

9. A redox fuel cell according to claim 1 wherein:
a. Z is B, P, S, As, Si, Ge, Al, Co, Mn or Se;
b. Z is P, S, Si, Al or Co
c. M is absent of Mo;
d. M is absent of any metals other than V and W;
e. 1 to 6 vanadium centres are present in the polyoxometallate;
f. M consists of a combination of W, V and/or Mo;
g. M consists of W; and/or
h. M_{c} comprises:
i. at least two W atoms;
ii. at least four W atoms; or
iii. at least six W atoms.

10. A redox fuel cell according to claim 1 wherein:
a. the polyoxometallate has the formula Xₐ[Z₁W₉V₃O₄₀];
b. the polyoxometallate has the formula Xₐ[Z₁W₁₁V₁O₄₀];
c. the polyoxometallate comprises H₆[AlW₁₁V₁O₄₀]; and/or
d. the polyoxometallate comprises K₂H₅[SiW₉V₃O₄₀].

11. A redox fuel cell according to claim 1 wherein X comprises:
a. a hydrogen and optionally alkali metal and/or alkaline earth metal ions;
b. an alkali metal ion and a hydrogen ion; and/or
c. one or more of El⁺, Na⁺, K⁺ or Li⁺.

12. A redox fuel cell according to claim 1 wherein the catholyte solution comprises at least one ancillary redox species.

13. A redox fuel cell according to claim 12 wherein the ancillary redox species is selected from ligated transition metal complexes, triphenylamine type materials, additional polyoxometallate species, and combinations thereof.

14. A redox fuel cell according to claim 13 wherein the transition metal(s) in the transition metal complexes are selected from manganese in oxidation states II-V, iron I-IV, copper I-III, cobalt I-III, nickel I-III, chromium (II-VII), titanium II-IV, tungsten IV-VI, vanadium II-V and molybdenum II-VI.

15. The redox fuel cell according to claim 13 wherein the additional polyoxometallate compound is represented by the formula:
Xₐ[Z_{b}M_{c}O_{d}]
wherein:
X is selected from hydrogen, alkali metals, alkaline earth metals, ammonium and combinations of two or more thereof;
Z is selected from B, P, S, As, Si, Ge, Ni, Rh, Sn, Al, Cu, I, Br, F, Fe, Co, Cr, Zn, H₂, Te, Mn and Se and combinations of two or more thereof;
M is a metal selected from Mo, W, V, Nb, Ta, Mn, Fe, Co, Cr, Ni, Zn Rh, Ru, Tl, Al, Ga, In and other metals selected from the 1^{st}, 2^{nd} and 3^{rd} transition metal series and the lanthanide series and combinations of two or more thereof;
a is a number of X necessary to charge balance the [Z_{b}M_{c}O_{d}]^{a-} anion;
b is from 0 to 20;
c is from 1 to 40; and
d is from 1 to 180.

16. A redox fuel cell according to claim 15 wherein the polyoxometallate is present at a concentration of between 5% and 15% the total amount of polyoxometallate.

17. A redox fuel cell according to claim 15 or claim 16 wherein the additional polyoxometallate comprises:
a. H₆₋ₓNaₓPMo₉V₃O₄₀ where x=0-3; and/or
b. H₆₋ₓNaₓPMo₈V₄O₄₀where x=0-4.

18. A redox fuel cell according to claim 13, wherein the triphenylamine type materials for use in combination with the polyoxometallates comprises formula (I): 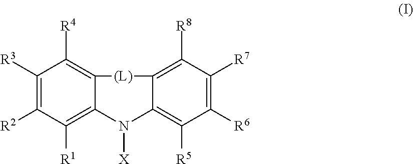
wherein:
X is selected from hydrogen and from functional groups comprising halogen, hydroxyl, amino, protonated amino, imino, nitro, cyano, acyl, acyloxy, sulphate, sulfonyl, sulfinyl, alkyamino, protonated alkylamino, quaternary alkylammonium, carboxy, carboxylic acid, ester, ether, amido, sulfonate, sulfonic acid, sulphonamide, phosphonic acid, phosphonate, phosphate, alkylsulfonyl, arylsulfonyl, alkoxycarbonyl, alkylsulfinyl, arylsulfinyl, alkylthio, arylthio, alkyl, alkoxy, oxyester, oxyamido, aryl, fused-aryl, arylamino, aryloxy, heterocycloalkyl, heteroaryl, fused-heteroaryl, (C₂-C₅)alkenyl, (C₂-C₅)alkynyl, azido, phenylsulfonyloxy, amino acid or a combination thereof;
R¹⁻⁸ are independently selected from hydrogen, halogen, hydroxyl, amino, protonated amino, imino, nitro, cyano, acyl, acyloxy, sulphate, sulfonyl, sulfinyl, alkyamino, protonated alkylamino, quaternary alkylammonium, carboxy, carboxylic acid, ester, ether, amido, sulfonate, sulfonic acid, sulphonamide, phosphonic acid, phosphonate, phosphate, alkylsulfonyl, arylsulfonyl, alkoxycarbonyl, alkylsulfinyl, arylsulfinyl, alkylthio, arylthio, alkyl, alkoxy, oxyester, oxyamido, aryl, fused-aryl, arylamino, aryloxy, heterocycloalkyl, heteroaryl, fused-heteroaryl, (C₂-C₅)alkenyl, (C₂-0C₅)alkynyl, azido, phenylsulfonyloxy, amino acid or a combination thereof;
R¹ and X and/or R⁵ and X may together form an optionally substituted ring structure;
R¹ and R² and/or R² and R³ and/or R³ and R⁴ and/or R⁴ and R⁸ and/or R⁸ and R⁷ and/or R⁷ and R⁶ and/or R⁶ and R⁵ may together form an optionally substituted ring structure; wherein (L) indicates the optional presence of a linking bond or group between the two neighbouring aromatic rings of the structure, and when present may form an optionally substituted ring structure with one or both of R⁴ and R⁸; and wherein at least one substituent group of the structure is a charge-modifying substituent.

19. A redox fuel cell according to claim 1 wherein the catholyte solution is substantially free from any ancillary redox species.

20. A redox fuel cell according to claim 1 wherein the concentration of polyoxometallate in the catholyte solution is:
a. between 0.01M and 0.6M;
b. between 0.1M and 0.6M; and/or
c. between 0.15M and 0.4M

21. A catholyte solution for use in a redox fuel cell comprising a polyoxometallate as defined in claim 1.

22. An electric source comprising redox fuel cell according to claim 1.

23. A method of operating a fuel cell according to claim 1, comprising the steps of:
a) forming H⁺ ions at an anode situated adjacent to an ion selective polymer electrolyte membrane;
b) supplying the catholyte of the invention with its redox couple in an oxidised state to a cathode situated oppositely adjacent to the ion selective polymer electrolyte membrane;
c) allowing the catalyst to become reduced upon contact with the cathode concomitantly with H⁺ ions passing through the membrane to balance charge;
d) optionally, passing the catholyte from the cathode to a reoxidation zone wherein the catalyst is reoxidised; and
e) optionally, passing the catholyte from the reoxidation zone to the catholyte reservoir.
